(19) United States
(12) Patent Application Publication
(10) Pub. No.: US 2006/0160922 A1
(43) Pub. Date: Jul. 20, 2006

(54) Biodegradable polymer compositions with controlled lifetimes

(76) Inventor: Gerald Scott, Richmond (GB)

Correspondence Address: MADSON & AUSTIN;GATEWAY TOWER WEST, SUITE 900, 15 WEST SOUTH TEMPLE, SALT LAKE CITY, UT, 84101, US

(21) Appl. No.: 11/373,344

(22) Filed: Mar. 10, 2006

Related U.S. Application Data
(63) Continuation of application No. 10/464,336, filed on Jun. 18, 2003.

(51) Int. Cl. C08K 5/00

(52) U.S. Cl. 523/127

(57) ABSTRACT

A polymer composition for making products having a controlled lifetime in an outdoor environment before degrading in a controlled way, comprises a hydrocarbon polymer that can biodegrade by an oxidative mechanism, and an antioxidant and a prooxidant that are soluble in the polymer. The antioxidant comprises a zinc, calcium or magnesium complex of a liquid containing one or more sulphur compounds attached to the metal ion, such as complexes of mercaptobenzothiazoles, mercaptobenzimidazoles, dithiophosphates and dithiocarbamates acid. The proxidant comprises a transition metal compound that is a carboxylate or an oxygen or nitrogen coordinated complex. The polymer compositions are particularly useful for making films, for example for agricultural or outdoor packaging purposes.

### CROSS-REFERENCE TO RELATED APPLICATION

This application is a continuation of U.S. application Ser. No. 10/464,336, filed Jun. 18, 2003, which is incorporated by reference.

### TECHNICAL FIELD OF THE INVENTION

This invention pertains to compositions comprising polymers that biodegrade in a controlled way in the environment, and in particular to hydrocarbon polymers that degrade primarily by an oxidative mechanism, where the degradation time is controlled by an additive system preferably comprising a combination of a transition metal compound which acts as a prooxidant and a zinc, calcium or magnesium complex which acts as an antioxidant.

### BACKGROUND OF THE INVENTION

It is known to add to polymers substances that promote their degradation so that they disintegrate and subsequently biodegrade in the environment. A number of applications of these systems have become important in recent years in order to reduce the amount of plastics wastes being buried in landfill and to return carbon-based polymers to the biological cycle in the form of compost or after degradation by spreading on land.

One important application of biodegradable plastics is in short-term applications (e.g. food packaging and landfill covers), where the product lifetime has to be just long enough to provide the appropriate shelf life and the service life required by the user of the product. This requirement has been achieved by the use of prooxidant transition metal ions in combination with conventional antioxidants (e.g. phenolic antioxidants). In the case of food wrapping materials, carrier bags and garden waste bags, the maximum lifetime required by the user is normally only weeks.

An important potential application is in agricultural packaging for fertilizer or animal feed bags where an outdoor lifetime of up to a year may be required. Closely related to this are agricultural auxiliaries such as silage and hay-wrap films and baler twines where an even longer lifetime may be required before degradation commences. Here the exact lifetime is not critical, provided it is long enough to satisfy the user requirements.

Another major use of time-controlled degradable plastics is in mulching films and tunnels where a relatively long user life is required (up to eighteen months) but here a critical requirement is that the plastic fragment rapidly and in a controlled way at the termination of the growing time of the crop and just before harvesting and subsequently biodegrades harmlessly in the soil. The role of the stabilizing component of the system is in this case much more critical, since if the films disintegrate too soon, the microenvironment at the root of the plant is destroyed with loss of crop yield. In the case of soft fruit and some vegetables the water and fertilizer are supplied by an irrigation system and if the films fail prematurely, rapid evaporation of water will occur. Furthermore, if the plastic films do not fragment under pressure at the time of harvest, they interfere with the automated cropping equipment. U.S. Pat. No. 4,519,161 (Gilead and Scott) describes the use of a combination of special photosensitive transition metal processing stabilizers with UV stabilizers that are destroyed by light and/or heat, liberating transition metal prooxidants that cause the polymer to rapidly disintegrate as a result of the combined effect of photo- and thermo-oxidation. A typical formulation disclosed in the patent is an iron dithiocarbamate (the photosensitizer) and a nickel dithiocarbamate (a thermo- and photo-antioxidant), which, when added to polyolefins in different combinations, allows the lifetime of the polymer to be varied over a wide range before biodegrading in the soil.

The application of the system described in U.S. Pat. No. 4,519,161 requires the separate manufacture of two speciality chemicals. The system has proved to be very successful in highly developed and automated agriculture procedures since the farmer is prepared to pay a premium for films that increase the value of his crops without the need to manually remove plastics detritus from the soil so that they do not interfere with subsequent cropping machinery and crop growing in subsequent years. But the system has been found to be less popular for other applications, for example in packaging, where the benefits of biodegradability are not primarily economic but environmental.

### SUMMARY OF THE INVENTION

The present inventor has discovered how to control the lifetime of degradable plastic products without the use of expensive speciality chemicals. According to the invention, there is provided a polymer composition for making products which have a controlled lifetime in an outdoor environment, such that the product has an application lifetime of a controlled duration and then fragments in a controlled way with bioassimilation during the following growing season. The compositions comprise a hydrocarbon polymer and an additive system comprising an antioxidant composition and a prooxidant composition, both of which are commodity chemicals. By means of selecting suitable levels of the antioxidant and prooxidant in the compositions, control over the application lifetime and rate of degradation of the product is achieved.

In one specific manifestation of the present invention, it has been observed unexpectedly that the combination of metal pro-oxidant compounds with typical rubber chemicals (well-known antioxidants) behaves as both a thermo- and photo-antioxidant during use, and as a thermo- and photo-pro-oxidant after use. This is the first time that a combination of a transition metal additive and a thermal antioxidant has been shown to initially protect the polymer against heat and light in the outdoor environment for a defined period and, at the end of the induction period, cause a rapid fragmentation of the polymer in compost or in sunlight.

### BRIEF DESCRIPTION OF THE PREFERRED EMBODIMENTS

The additive system used in the invention comprises a combination of an antioxidant compound and a prooxidant compound, both of which are metal compounds or complexes that are relatively soluble in the polymer. In order to be soluble, these additives contain long chain or, preferably, branched chain, organic residues. Normally the alkyl substituents should contain more than four carbon atoms in order to provide good compatibility with the polymer but optimal activity is obtained at C₈ and above where surface “blooming” does not normally occur.

The prooxidant is a transition metal compound that is a carboxylate or an oxygen- or nitrogen- coordinated metal complex. Preferred carboxylates are stearates, laurates and synthetic branched-chain C₄-C₁₈ carboxylates. Commercially available β-diketones such as acetylacetone and 2,2′-methylenebis (1,3-cyclohexane) dienone and its derivatives may be advantageous when good solubility in the polymer is essential. The transition metal ion of the prooxidant can include Mn, Ce, Cr, Cu, Ni, Co, Fe, Mo, W and V. Cobalt is preferred because it gives the best balance of prooxidant and antioxidant properties and at low concentrations it is non-toxic to animals and plants. Preferred cobalt compounds are cobalt stearate, naphthenate, branched chain hexanoate, octanoate and nonanoate. In general, branched chain alkanoates are more soluble than straight chain. The prooxidant compounds are widely used in the chemical and polymer industries to accelerate free radical peroxidation and are commercially available.

The antioxidant compounds that are used in the invention are zinc, calcium and magnesium complexes of ligands that contain one or more sulphur compounds attached to the metal ion. Preferred are complexes of dithiocarbamic acids, mercaptobenzothiazoles and mercaptobenzimidazoles, since these are readily available and relatively inexpensive as rubber compounding agents, and the dithiophosphoric acids that are also readily available and inexpensive oil additives. The dithiocarbamate complexes may contain aliphatic and/or aromatic groups attached to nitrogen and the dithiophosphate complexes may contain aromatic and/or aliphatic groups attached to oxygen. The benzothiazoles and benzoimidazoles may contain other substituents such as alkyl in the aromatic rings. A particularly preferred antioxidant is zinc di-iso-nonyl dithiocarbamate (ZnDNC).

The polymers that can be used in the compositions of the invention are preferably hydrocarbons that can degrade in an outdoor environment, primarily by an oxidative mechanism, to give, after complete biodegradation, only carbon dioxide and water. Preferred polymers are saturated polyolefins, for example polyethylene, polypropylene and their copolymers; polystyrene and its blends with polyunsaturated polymers; unsaturated polymers such as polydiene rubber, for example cis-polyisoprene (natural or synthetic); polybutadiene; styrene-butadiene; copolymers of unsaturated polymers with saturated polymers, such as acrylonitrile-butadiene-styrene (ABS); and block co-polymers, for example styrene-butadiene-styrene (SBS); and mixtures of the foregoing polymers. The process can also be applied to other carbon-chain polymers such as polyvinyl chloride and other chlorinated polymers. These are not preferred at present, since little is known about the environmental acceptability of the oxidation products, which may well be low molecular weight chlorine compounds of unknown toxicity. Unlike the hydrocarbon polymers, organic chlorine compounds do not break down rapidly to carbon dioxide and water.

The polymer compositions of the invention can be processed by conventional and well-known processing methods, including film blowing and molding, into products that include products for agricultural use such as mulching films, tunnels, silage-wrap and hay-wrap films, baler twines and fixing clips fruit, in forestry as ground cover and tree shelters, in horticulture for disposable pots and containers and in packaging as fertilizer bags, animal feed bags and wrapping films. It is convenient and operationally preferably to pre-form a concentrate (masterbatch) of the additives in a hydrocarbon polymer, which may be the same as, or different from, the polymer to which it is to be added by dilution to the required concentration. It is also desirable to produce the concentrates in a high shear mixer to provide maximum physical and possibly chemical reaction between the additives. For speed of mixing and maximum effectiveness of the active ingredients, they should be added to the mixer in a finely divided form.

In the polymer compositions of the invention, the additive system initially protects the molded or extruded polymer product against heat and light in an outdoor or indoor environment for a defined period of time, namely the intended application life of the product (also referred to as the induction period), during which the product is in use or stored, for example as a mulching film. At the end of the application life, the additive system causes rapid embrittlement, and therefore disintegration, of the polymer, as the product is either further exposed to sunlight or is in a landfill or compost and thereby subjected to heat. The concentrations of the antioxidant and the prooxidant in the polymer compositions govern the length of the application life and the rate of disintegration of the product. The antioxidant acts as a heat stabilizer during processing of the polymer, e.g. blowing the film or molding the product, and as a thermal antioxidant and light stabilizer during the application life of the product. At the end of the application life, the antioxidant is destroyed by heat or light or a combination of the two and ceases to protect the polymer from oxidation. The released transition metal ion of the prooxidant then catalyzes the peroxidation of the polymer. Increasing the concentration of the antioxidant increases the application life of the product. Increasing the concentration of the prooxidant increases the rate of fragmentation of the product, at the end of the application life. If a given concentration of prooxidant, PO₁, is combined with various concentrations of antioxidant, i.e. AO₁, AO₂, and AO₃, where AO₁ is less than AO₂ is less than AO₃, three different product lifetimes will be obtained, AO₃ producing the longest product lifetime and AO₁ the shortest, but the rate of disintegration of the end of the product lifetime will be very similar. On the other hand, if a higher concentration of prooxidant, PO₂, where PO₂ is greater than PO₁, is combined with AO₁, AO₂ and AO₃, then a faster rate of disintegration will be obtained at the end of the induction period, but the induction periods will be rather shorter than for the compositions having PO₁, and higher concentrations of antioxidant will be required to produce the same induction periods. The choice of combinations will depend on the application of the product and whether a fast disintegration is required (for example in short-term mulching films, short-life packaging such as cigarette wrapping films, and personal hygiene products such as diapers) or where a slower disintegration is required (e.g. for long-term mulching films, silage films, tree shelters or in agricultural packaging and baler twines. It will be apparent that the invention provides control over the induction period of the polymer product once it is exposed to the environment, over a wide range of times.

Preferred ranges for the antioxidant are 0.01-0.5% by weight of the final product. Preferred ranges for the prooxidant are 0.05-4% by weight. The additive system may be used to vary the application lifetime of the product on either side of the natural lifetime of the polymer as manufactured. For example, if a very long product lifetime is required, both the prooxidant and antioxidant concentrations may be in the region of 0.1 to 4% by weight of the final product. If a shorter lifetime than the natural lifetime of the polymer is required, then the prooxidant concentration would be about 0.1% or greater and the antioxidant concentration would be 0.05% or less.

The preferred additive systems of the present invention, notably cobalt, nickel and manganese, are ecologically harmless in the soil, since they are widely distributed in considerable concentrations in agricultural soils and are generally trace metals required by the growing plants. Neither the metals nor their salts or complexes have an adverse effect on the rate of seed germination, plant growth and the effects on macroorganisms of the soil. The sulphur ligands of the antioxidants are converted to harmless sulphates and oxides during composting or in the soil over a longer time.

It may be noted that the antioxidant compositions used in the invention have no utility on their own as light stabilizers for hydrocarbon polymers. Surprisingly, when they are formulated with the prooxidant compounds of the invention in the polymer compositions, they function as light stabilizers for the polymer, making the products suitable for applications where they will be exposed to sunlight during the induction period, for example outdoor packaging, silage films, mulching films, etc. It is believed that the antioxidant and prooxidant react together in the polymer melt to impart light stability to the product. However, this invention is not bound or limited by any particular theory or mechanism of operation of the additive system.

### EXAMPLE 1

Compositions were made of low density polyethelene with an additive system comprising ZnDNC and cobalt stearate. The process can be carried out with any commercial low density polyethylene, high density polyethylene or linear low density polyethylene provided they do not contain other than a minimal amount of antioxidant. In this example, the polymer was commercial lightly stabilised polyethylene. First, to prepare a concentrate, ZnDNC was blended with the polyethylene in the concentrations shown in Table I in a high shear mixer (Brabender Plasticorder, Buss-Ko kneader or twin screw extruder) at 200° C. for ten minutes. The product was extruded as pellets and divided into 5 parts, each of which was added separately in a high shear mixer to 2 grams cobalt stearate per 100 grams of the mixture and processed at 200° C. for ten minutes. At the end of this period, the color of the concentrate was uniform. If there were any streaks, mixing would be continued until homogeneity was obtained. Each of these concentrates was then added to the polyethylene resin at a concentration of 5 grams per 100 grams in a conventional film-blowing machine. The 25 μm films produced were evaluated in an accelerated weathering cabinet (sunlamp and black lamp) to measure the time to embrittlement. The embrittlement time was routinely measured as time to fracture on bending the film through 180°. The time correlated with approximately 90% loss of elongation at break in an Instron stress-strain tester. This test was also carried out in a falling ball impact tester in which the height of the ball was empirically adjusted to correlate with the Instron test. The time to embrittlement is shown in Table I.

TABLE 1

| | Concentrate | | Molding Composition | Embrittlement |
|---|---|---|---|---|
| | ZnDNC | Cobalt Stearate | ZnDNC | Time |
| | (wt %) | (wt %) | (wt %) | (hours) |
| 1. | 0 | 2 | 0 | 320 |
| 2. | 0.1 | 2 | 0.005 | 450 |
| 3. | 0.5 | 2 | 0.025 | 750 |
| 4. | 1.0 | 2 | 0.05 | 1220 |
| 5. | 2.0 | 2 | 0.1 | 2300 |
| 6. | 3.0 | 2 | 0.15 | 2550 |
| 7. | 5.0 | 2 | 0.25 | 2900 |

The blown films of Example 1 were subjected to heat aging tests in a forced air oven. There was a general equivalence in time to embrittlement in UV radiation in the S/B lamp at 40° C. and that of heat aging at 70° C.

It was found that low concentrations of ZnDNC, up to 0.2 grams per 100 grams of final product in the samples of Example 1, provide effective polymer processing and shelf stability but still permit rapid embrittlement in heat aging tests at 70° C., a temperature experienced in compost. By selection of the ZnDNC concentration, embrittlement can be achieved during a commercial composting process, which typically lasts six months.

### EXAMPLE 2

Eleven different formulations of concentrate were prepared using low density polyethylene (Exxon LD 509) as the carrier resin and either ZnDNC (Arbestab-Z) or butylated hydroxy toluene (BHT) as the antioxidant, or having no antioxidant, and cobalt stearate as the prooxidant. The pro-oxidant was pulverized before compounding using a high speed mixer. These ingredients were compounded and pelletized in a twin-screw compounding extruder (APV Baker-Perkins, model 30 AC). An underwater pelletizing system was used to prevent any oxidation of active ingredients during the compounding process. The concentrate was dry-blended with low density polyethylene resin (Dow 609 A) to make film formulations. These were then extruded to a film using a Hosakawa-Alpine blown film mono-layer line. The film thickness was 50 microns.

The films produced were evaluated using an accelerated weathering cabinet to measure the time to embrittlement. Both ultraviolet embrittlement time and thermal embrittlement time at 71° C. were measured. Embrittlement was determined in accordance with ASTM standard D3826, embrittlement being the point at which 75% of specimens tested had 5% or less tensile elongation at break. The melt flow index (MFI) of the films was measured using a Tinius Olsen MP 993A extrusion plastometer. MFI is inversely proportional to molecular weight so higher MFI's correspond to high degrees of degradation. The compositions of the eleven formulations are summarized in Table 2. The test results for the films are summarized in Table 3, with the eleven film compositions grouped into sets A to J for purposes of showing the effect of the ZnDNC antioxidant relative to BHT or no antioxidant.

TABLE 2

| | | | | | Molding Composition [symbol] | | | | |
|---|---|---|---|---|---|---|---|---|---|
| | Concentrate | | | | | | | C | F |
| | PO | AO₁ | AO₂ | Resin | PO | AO₁ | AO₂ | Resin | Resin |
| 1. | 5.455 | 3.644 | — | 100 | 0.155 | 0.100 | — | 2.835 | 100 |
| 2. | 5.359 | 1.822 | — | 100 | 0.155 | 0.050 | — | 2.886 | 100 |
| 3. | 5.282 | 0.359 | — | 100 | 0.155 | 0.010 | — | 2.928 | 100 |
| 4. | 33.557 | 0.671 | — | 100 | 0.773 | 0.015 | — | 2.304 | 100 |
| 5. | 33.784 | 1.351 | — | 100 | 0.773 | 0.030 | — | 2.289 | 100 |
| 6. | 5.263 | — | — | 100 | 0.155 | — | — | 2.938 | 100 |
| 7. | 33.333 | — | — | 100 | 0.773 | — | — | 2.319 | 100 |
| 8. | 5.455 | — | 3.644 | 100 | 0.155 | — | 0.100 | 2.835 | 100 |
| 9. | 5.359 | — | 1.822 | 100 | 0.155 | — | 0.050 | 2.886 | 100 |
| 10. | 33.557 | — | 0.671 | 100 | 0.773 | — | 0.015 | 2.304 | 100 |
| 11. | 33.784 | — | 1.351 | 100 | 0.773 | — | 0.030 | 2.289 | 100 |

Notes:
1. PO = pro-oxidant (cobalt stearate)
2. AO₁ = ZnDNC
3. AO₂ = BHT
4. C Resin = Concentrate resin (low density polyethylene)
5. F Resin = Film resin (low density polyethylene)
6. All concentrations in parts per 100 parts of resin (by weight).

TABLE 3

| | | UV embrittlement | MFI | Thermal embrittlement |
|---|---|---|---|---|
| Set | Formulations | time (hours) | g/10 min | time at 71° C. (hours) |
| A | 1 | 350 | 1.44 | 72 |
| | 8 | 120 | 0.80 | 96 |
| B | 2 | 250 | 1.39 | 72 |
| | 9 | 100 | 0.80 | 96 |
| C | 4 | 130 | 1.78 | 72 |
| | 10 | 90 | 1.10 | 96 |
| D | 5 | 220 | 1.79 | 72 |
| | 11 | 96 | 1.06 | 96 |
| E | 1 | 400 | 1.44 | 72 |
| | 6 | 70 | 1.29 | 60 |
| F | 2 | 250 | 1.39 | 72 |
| | 6 | 70 | 1.29 | 60 |
| G | 3 | 130 | 1.33 | 72 |
| | 6 | 75 | 1.29 | 60 |
| H | 4 | 130 | 1.78 | 72 |
| | 7 | 85 | 1.63 | 48 |
| I | 5 | 230 | 1.79 | 72 |
| | 7 | 90 | 1.63 | 48 |
| J | 4 | 130 | 1.78 | 72 |
| | 10 | 96 | 1.10 | 96 |
| | 7 | 90 | 1.65 | 48 |

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A polymer composition for manufacture of a product having a controlled lifetime in an outdoor or indoor environment, comprising:
(a) a carbon-chain polymer;
(b) an antioxidant soluble in said polymer, comprising a zinc, calcium or magnesium complex; and
(c) a prooxidant soluble in said polymer, comprising a transition metal carboxylate compound.

2. A composition according to claim 1 wherein said polymer comprises a polymer capable of degrading by an oxidative mechanism to form carbon dioxide and water.

3. A composition according to claim 2 wherein said polymer comprises a polyolefin.

4. A composition according to claim 3 wherein said polyolefin is selected from the group consisting of polyethylene, polypropylene, polystyrene and their copolymers and blends.

5. A composition according to claim 2 wherein said polymer contains unsaturation.

6. A composition according to claim 5 wherein said polymer is polybutadiene, polyisoprene, styrene-butadiene copolymers (SBS, HIPS), or acrylonitrile-butadiene-styrene (ABS).

7. A composition according to claim 2 wherein said polymer comprises a co-polymer or blend of an unsaturated polymer with a saturated carbon-chain polymer.

8. A composition according to claim 7 wherein the said unsaturated carbon-chain polymer is SBS or ABS.

9. A composition according to claim 1 wherein said antioxidant is selected from the group consisting of zinc, calcium or magnesium complexes of:
(a) mercaptobenzothiazole (MBT) and its alkylated derivatives;
(b) mercaptobenzimidazole (MBI) and its alkylated derivatives;
(c) dialkyl, diaryl or alkyl aryl dithiophosphoric acids;
(d) dialkyl, diaryl or alkyl aryl dithiocarbamic acids.

10. A composition according to claim 9 wherein said zinc complex is zinc di-iso-nonyl dithiocarbamate.

11. A composition according to claim 1 wherein said transition metal carboxylate compound is a cobalt, manganese, cerium, chromium, copper or nickel compound.

12. A composition according to claim 1 wherein said carboxylate compound is selected from the group consisting of stearate, laurate and synthetic branched-chain C₄ to C₁₈ carboxylate.

13. A composition according to claim 11 wherein said transition metal carboxylate compound is cobalt stearate.

14. A composition according to claim 1 wherein said polymer composition contains 0.001-1.5% by weight of said antioxidant, relative to the total weight of said composition.

15. A composition according to claim 1 wherein said polymer composition contains 0.001-4% by weight of said prooxidant, relative to the total weight of said composition.

16. A composition according to claim 1 wherein said polymer composition contains 0.01% by weight or more of said prooxidant and 1% by weight or less of said antioxidant, relative to the total weight of said composition.

17. A composition according to claim 1 wherein said polymer composition comprises a concentrate for dilution with a hydrocarbon polymer.

18. A molded, extruded, cast or blown polymeric product made from the composition of claim 1.

19. A film obtained from the composition of claim 1.

20. A polymer composition for manufacture of a product having a controlled lifetime in an outdoor or indoor environment, comprising:
(a) a carbon-chain polymer;
(b) a prooxidant soluble in said polymer, comprising a transition metal carboxylate compound; and
(c) an antioxidant soluble in said polymer.
